(19) United States
(12) Patent Application Publication
(10) Pub. No.: US 2014/0246548 A1
(43) Pub. Date: Sep. 4, 2014

(54) ROTATING HOLDER ASSEMBLY AND KIT

(71) Applicants: Alan G. Madsen, Virginia Beach, VA (US); Richard W. Lally, Virginia Beach, VA (US); April S. Stremel, Virginia Beach, VA (US)

(72) Inventors: Alan G. Madsen, Virginia Beach, VA (US); Richard W. Lally, Virginia Beach, VA (US); April S. Stremel, Virginia Beach, VA (US)

(21) Appl. No.: 14/190,172

(22) Filed: Feb. 26, 2014

Related U.S. Application Data
(60) Provisional application No. 61/772,090, filed on Mar. 4, 2013.

(51) Int. Cl. F16M 13/02

(52) U.S. Cl. CPC F16M 13/022
USPC 248/218.4; 248/230.8; 248/291.1

(57) ABSTRACT

A rotating holder assembly includes a base, a strap assembly, a plate, and an accessory holder. The base defines opposing surfaces, an open-ended tubular portion located between the two surfaces, a cylindrical post coupled to and extending perpendicularly away from one surface, and a cap coupled to the outboard end of the post. The cap defines a substantially hemispherical shape having a diameter that is greater than a diameter of the post. The strap assembly includes a stretchable strap extending through the tubular portion, and a coupler for securing the stretchable strap into a loop of selectable size. The plate has a hole extending therethrough having an axial length that is less than an axial length of the post, and a diameter that is less than the diameter of the cap and greater than the diameter of the post. The accessory holder is coupled to the plate.

Pursuant to 35 U.S.C. §119, the benefit of priority from provisional application 61/772,090, with a filing date of Mar. 4, 2013, is claimed for this non-provisional application.

### FIELD OF THE INVENTION

The invention relates generally to article holding assemblies, and more particularly to a rotating holder assembly.

### BACKGROUND OF THE INVENTION

Modern hospitals and other patient care facilities utilize technologically-advanced beds that incorporate bed adjustment controls, patient communication systems, and alerting systems. However, even with all of these advancements, a patient's bed still tends to be the collection point for medical treatment apparatus (e.g., intravenous or IV tubes used for feeding and/or medication, breathing tubes, etc.), personal hygiene accessories (e.g., bed pan, urinal, etc.), and various patient comfort accessories (e.g., corded television and room lighting remote, corded room telephone, etc.). Patients and their caregivers frequently spend time trying to locate items, untangle these items, and/or clean up when the items fall and break, spill, etc.

### SUMMARY OF THE INVENTION

Accordingly, it is an object of the present invention to provide a system that can improve placement of medical apparatus, personal hygiene accessories, and patient comfort accessories needed at a hospital bed.

Another object of the present invention is to provide a system that can hold a variety of medical apparatus, personal hygiene accessories, and patient comfort accessories within reach of a patient lying in a hospital bed.

Other objects and advantages of the present invention will become more obvious hereinafter in the specification and drawings.

In accordance with the present invention, a rotating holder assembly includes a base, a strap assembly, a plate, and an accessory holder. The base defines
a first surface and a second surface in opposition to the first surface,
an open-ended tubular portion located between the first surface and second surface wherein the tubular portion has an elongate cross-sectional shape,
a cylindrical post coupled to and extending perpendicularly away from the first surface wherein the post terminates in an outboard end, and
a cap coupled to the outboard end of the post wherein the cap defines a substantially hemispherical shape extending away from the outboard end and wherein a diameter of the cap is greater than a diameter of the post.
   The strap assembly includes (i) a stretchable strap extending through the tubular portion of the base, and (ii) a coupler for securing the stretchable strap into a loop of selectable size. The plate has a hole extending therethrough having an axial length that is less than an axial length of the post, and having a diameter that is less than the diameter of the cap and greater than the diameter of the post. The accessory holder is coupled to the plate.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is an exploded side view of a rotating holder assembly in accordance with an embodiment of the present invention;

FIG. 2 is an isolated top view of the base taken along 2-2 in FIG. 1;

FIG. 3 is an isolated top view of the plate and a D-ring accessory holder taken along 3-3 in FIG. 1;

FIG. 4 is an isolated view of the back side of the plate taken along line 4-4 in FIG. 1;

FIG. 5 is a side view of a base having one non-skid surface in accordance with another embodiment of the present invention;

FIG. 6 is a side view of a base having a non-skid material coupled to one surface thereof in accordance with another embodiment of the present invention;

FIG. 7 is a side view of a base having a split post and cap in accordance with another embodiment of the present invention;

FIG. 8 is a head-on view of the base and split post/cap taken along line 8-8 in FIG. 1;

FIG. 9 is a perspective view of a plate and an accessory cradle in accordance with an embodiment of the present invention;

FIG. 10 is a perspective view of a plate and an accessory cradle in accordance with another embodiment of the present invention;

FIG. 11 is a top view of a plate and a multi-tube guide in accordance with another embodiment of the present invention;

FIG. 12 is a perspective view of the rotating holder assembly positioned adjacent a hospital bed rail; and

FIG. 13 illustrates the rotating holder assembly coupled to a hospital bed's rail that has been raised to an angular orientation with respect to the floor supporting the bed.

### DETAILED DESCRIPTION OF THE INVENTION

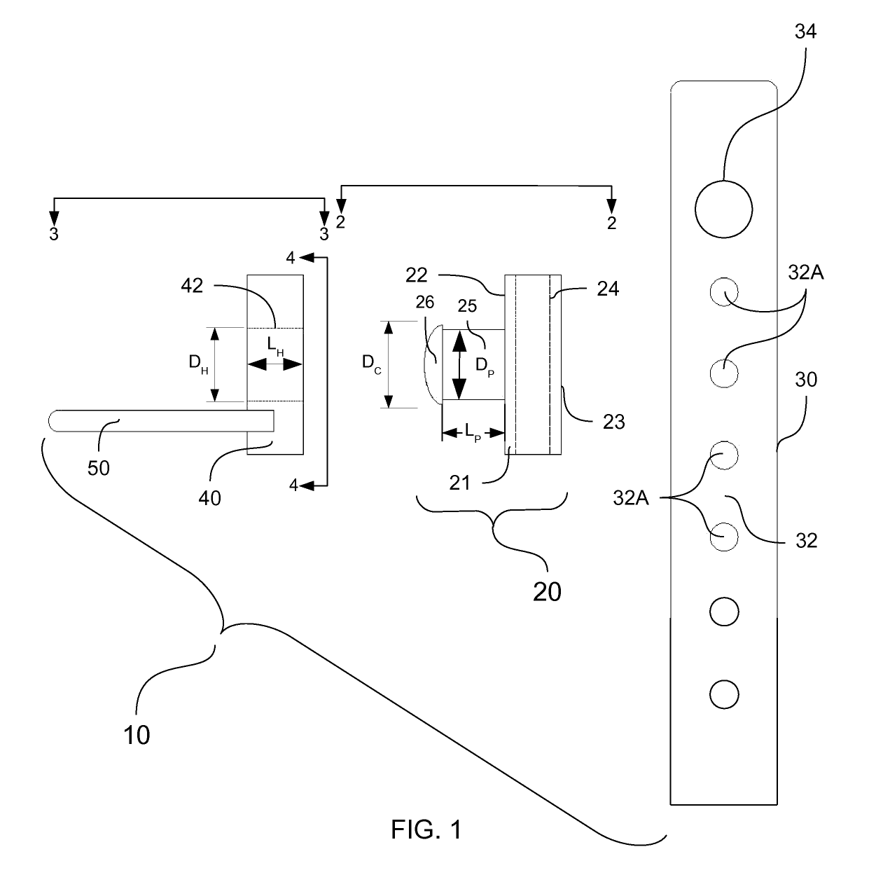

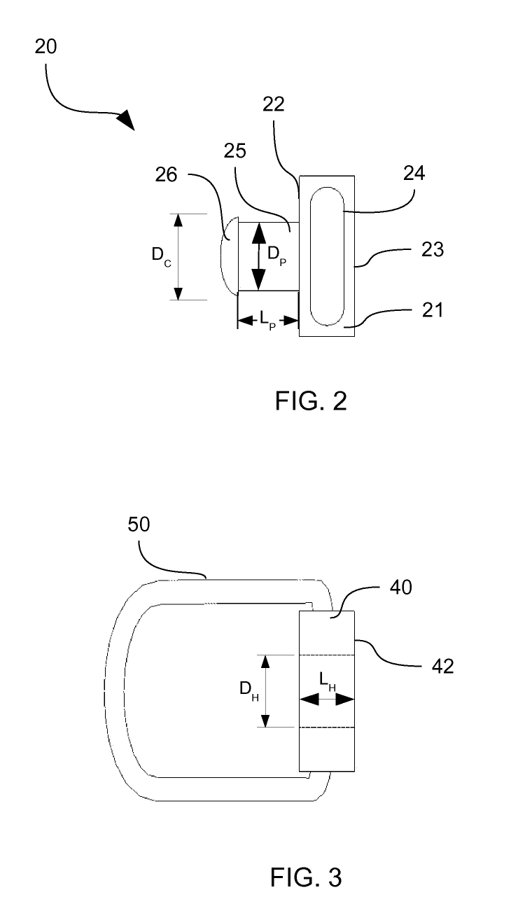

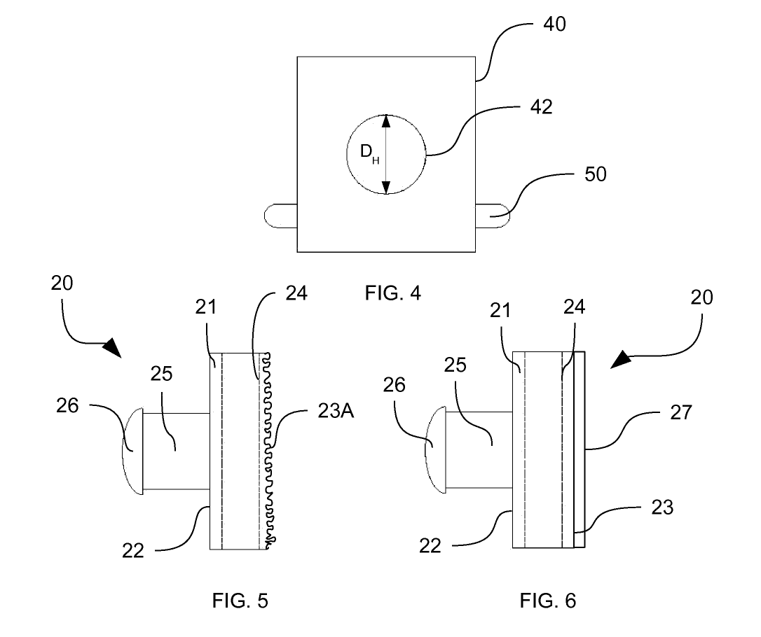

Referring now to the drawings, simultaneous reference will be made to FIGS. 1-4 where a rotating holder assembly 10 in accordance with an embodiment of the present invention is shown in an exploded in view in FIG. 1. Various parts of assembly 10 are shown in isolated views in FIGS. 2-4. Rotating holder assembly 10 can be attached to a number of different support environments to hold an item in a vertical orientation regardless of the angular orientation of the support environment. By way of an illustrative example to be explained later herein, assembly 10 can be coupled to a portion of a bed rail of a hospital bed. More specifically, assembly 10 can be coupled to a portion of a hospital bed's rail adjacent to the bed's torso support portion that generally can be angled up/down for patient comfort. As will also be explained herein, assembly 10 can be readily configured to hold a variety of medical apparatus such as fluid tubes, hygiene accessories such as a urinal bottle, or patient comfort accessories such as the hospital room's corded television remote or telephone.

Rotating holder assembly 10 includes a base 20, a strap assembly 30, and an adapter plate 40 that generally incorporates an accessory holder or has an accessory holder coupled thereto. In the illustrated embodiment, a D-ring accessory holder 50 is coupled to adapter plate 40. When assembly 10 is to be coupled to the torso-tilting portion of a hospital bed rail, D-ring accessory holder 50 can be sized and shaped to receive the handle of a standard urinal bottle (not shown).

Base 20 has a rigid main body 21 that can have any perimeter shape and be made of plastic, metal, a composite, etc., without departing from the scope of the present invention. Main body 21 defines two opposing surfaces 22 and 23, and an open-ended tube 24 extending through main body 21 between surfaces 22 and 23. The cross-sectional shape of tube 24 is generally elongated (FIG. 2) and is sized to slidingly receive the strap portion 32 of strap assembly 30. Extending perpendicularly away from surface 22 is a cylindrical post 25 showing an axial length “L_{P}”. Post 25 can be coupled to main body 21 or made integral therewith without departing from the scope of the present invention. The diameter of post 25 is indicated by “D_{P}”. The outboard end 25A of post 25 has a cap 26 coupled thereto. Cap 26 can be attachable to outboard end 25A or be integral with post 25 without departing from the scope of the present invention. In general, cap 26 defines a substantially hemispherical shape whose diameter “D_{C}” is greater than diameter D_{P} of post 25. As will be explained in more detail below, cap 26 must permit the coupling of plate 40 to base 20, while also retaining plate 40 on base 20. Cap 26 can achieve these functions by being a rigid material attachable to post 25, by being a radially compressible material attachable or integrated with post 25 such that D_{C} is reduced when cap 26 is radially compressed, or constructed in a way that allows D_{C} to be reduced when cap 26 undergoes radial compression.

Strap assembly 30 includes a longitudinally stretchable strap 32 and a coupler 34 coupled to strap 32. In general, strap assembly 30 is constructed to allow strap 32 to wrap around a support environment (e.g. a hospital bed's rail) and be held in place by coupler 34 such that strap assembly 30 forms a loop of selectable size around the support environment. Strap 32 can be made from a natural or synthetic rubber or rubber-type material to provide stretchable tension as well as presenting a non-skid in interface with the support environment. By way of example, strap 32 can include holes 32A that provide secure and indexed engagement with a post or stud coupler 34. However, it is to be understood that strap 32 and coupler 34 could be constructed in a variety of ways without departing from the scope of the present invention. For example, strap 32 could include a series of raised ridges and coupler could include a slot that engages a selected one of the ridges in the strap when the strap is wrapped around a support environment.

Plate 40 is generally rigid and can have any perimeter shape and be made of plastic, metal, composite, etc., without departing from the scope of the present invention. Plate 40 has a cylindrical hole 42 defined therein. The axial length of hole 42 is designated “L_{H}” and the diameter of hole 42 is designated as “D_{H}”. For purposes of the present invention, the length L_{H} of hole 42 must be less than the length L_{P} of post 25, while the diameter D_{H} of hole 42 must be greater than the diameter D_{P} of post 25. Dimensioning plate 40 in this way allows plate 40 to rest on post 25, be held in place by cap 26, and freely rotate about post 25. When assembly 10 is to be used to hold an accessory of some relatively considerable weight (e.g., a filled urinal bottle), the length L_{H} of hole 42 should be between approximately 0.8 to approximately 0.9 times the length L_{P} of post 25. Dimensioning hole 42 in this way will assure that plate 40 can freely rotate on post 25 when a heavier accessory is hanging from D-ring holder 50.

D-ring accessory holder 50 is a rigid material that can be coupled to plate 40 or made integral with plate 40 without departing from the scope of the present invention. It is to be understood that the size and shape of D-ring holder 50 are not limitations of the present invention. For example, an open-ended and vertically-oriented sleeve could be used in place of D-ring holder 50 without departing from the scope of the present invention.

When using assembly 10, surface 23 of base 20 will interface with the surface of a support environment (e.g., a hospital bed's rail). To enhance the grip between base 20 and the surface of a support environment, surface 23 can be roughened to define a non-skid surface 23A as illustrated in FIG. 5. Another option is to apply a non-skid material 27 (e.g., rubber, foam, etc.) to surface 23 as illustrated in FIG. 6.

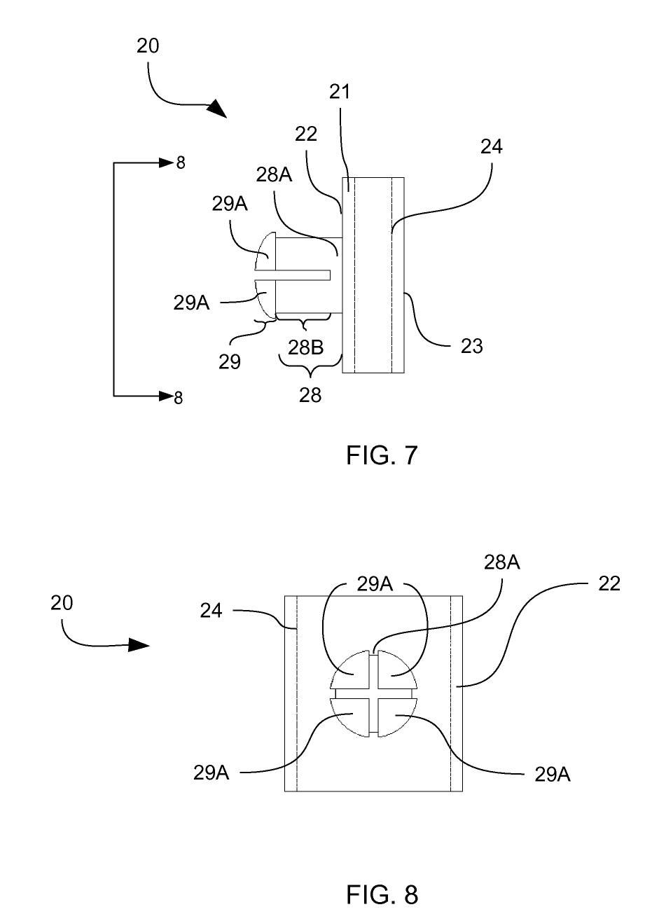

As mentioned above, cap 26 must permit the coupling of plate 40 to base 20, while also retaining plate 40 on base 20. Accordingly, cap 26 can be removable/attachable to the outboard end of post 26, or be made from a radially compressible material that can be pushed through hole 42 of plate 40 as plate 40 is pressed into engagement therewith and then spring back to retain plate 40 on post 25. An integrated or monolithic embodiment of base 20 that provides these functions is illustrated in FIGS. 7-8. In this embodiment, a split post 28 and a split cap 29 are integral with one another and with main body 21. Split post 28 includes an un-split portion 28A coupled to main body 21 for strength and stability, and a split portion 28B. Split portion 28B defines four post sections, two of which are visible in FIG. 7. It is to be understood that two more mirror-imaged post sections comprise the remainder of split portion 28B.

Split cap 29 has corresponding four cap sections 29A with each cap section 29A coupled to a corresponding post section of split portion 28B and with cap sections 29A being separated from one another as illustrated in FIG. 8. The combination of cap sections 29A defining split cap 29 form a substantially hemispherical shape. When no radial compression forces are applied about split cap 29, the diameter D_{C} of split cap 29 has all of the retention attributes described above for cap 26. However, when radial compression forces are applied to split cap 29, diameter D_{C} is reduced. More specifically, split post 28 and split cap 29 are configured such that diameter D_{C} can be reduced such that it is less than diameter D_{H} of hole 42 in plate 40. In this way, plate 40 could be pushed onto/over split cap 29 to radial compress cap sections 29A toward one another. Plate 40 would be pushed until coming to rest on split post 28 whereby split cap 29 then springs back to its original position (i.e., D_{C} is greater than D_{H}) to retain plate 40 in place.

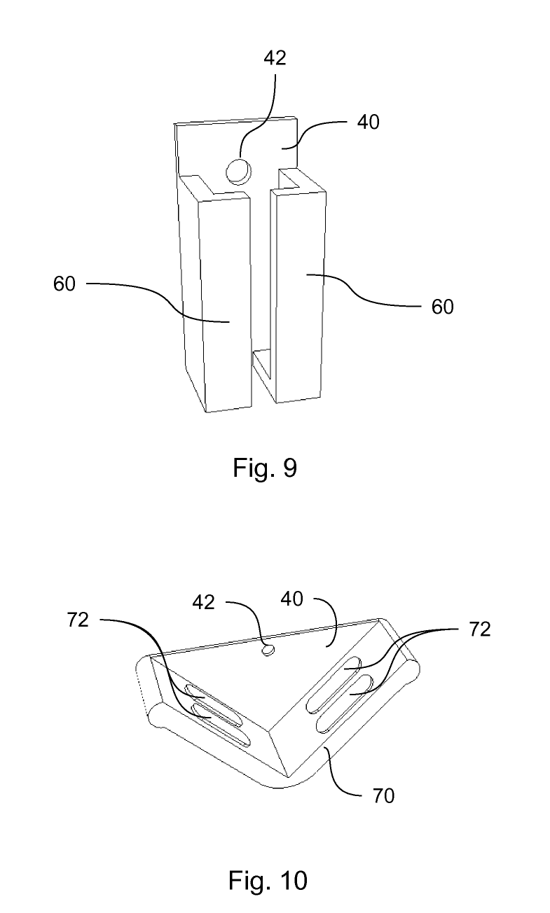

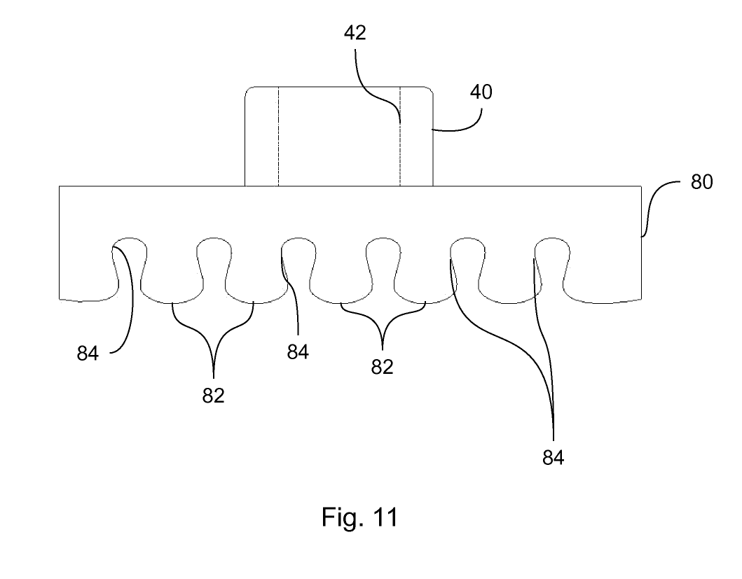

The present invention can also provide different or additional plate and accessory holder combinations as evidenced by the examples illustrated in FIGS. 9-11. The present invention can be realized as a kit that includes base 20, strap assembly 30, plate 40/D-ring holder 50, and one or more of the accessory holders illustrated in FIGS. 9-11. In FIG. 9, plate 40 has a cradle holder 60 coupled thereto. Cradler holder 60 could be used to support various corded patient comfort items such as a television remote or room telephone. FIG. 10 illustrates another cradle holder 70 coupled to plate 40. Cradle holder 70 is an open V-shape and can have non-skid pads 72 coupled thereto to aid in the retention of an accessory (not shown) placed therein. FIG. 11 is a top view of a plate 40 having a multi-tube holder 80 coupled thereto. Multi-tube holder 80 can be a monolithic structure with fingers 82 defining open-sided tube retention guides 84. In general, each guide 84 supports retention of one medical tube disposed therein. The number, size and shape of guides 84 are not limitations of the present invention.

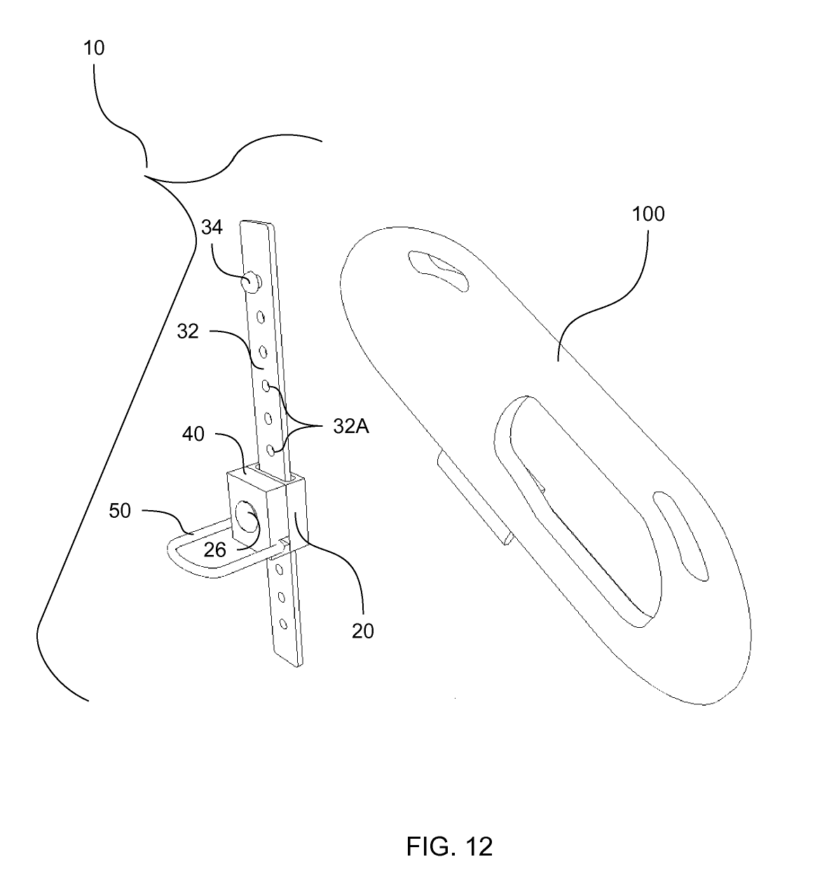

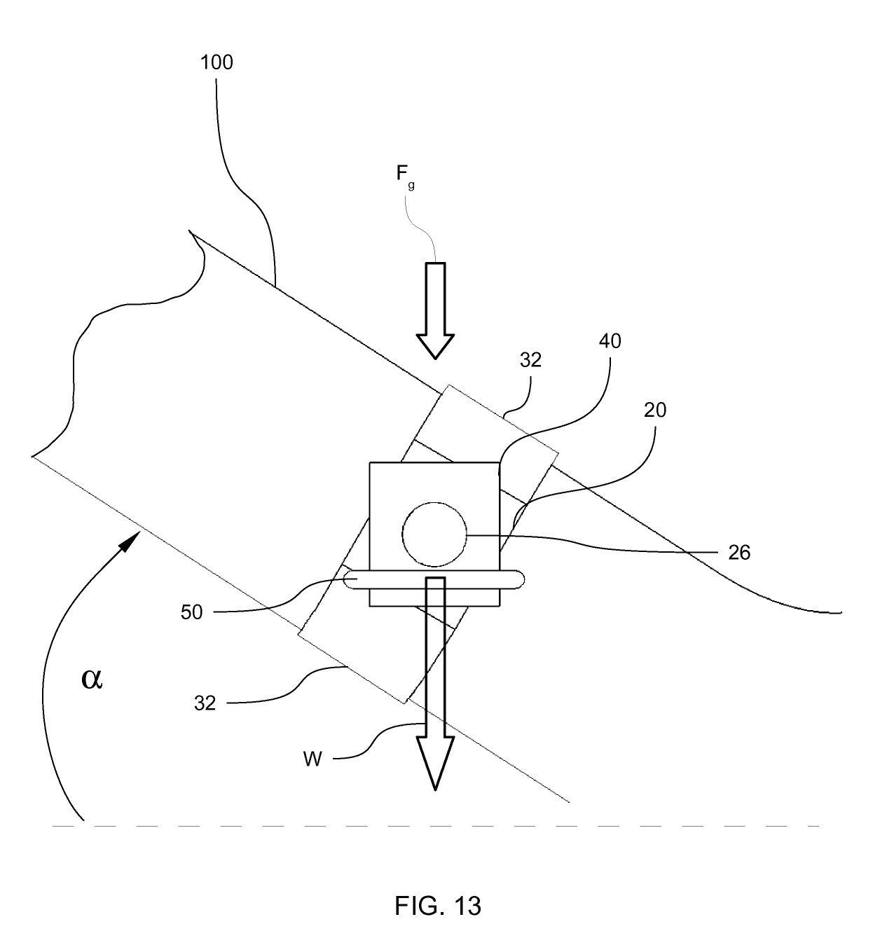

Regardless of its particular features, the rotating holder assembly of the present invention functions in the same fashion. By way of an illustrative example, FIG. 12 illustrates holder assembly 10 just prior to attachment to a hospital bed's rail 100. It will be assumed that rail 100 is attached to the portion of a hospital bed that supports a patient's torso such that rail 100 will likely be placed at a variety of angular orientations relative to the floor (not shown) on which the hospital bed rests. Briefly, strap 32 is wrapped in tension about rail 100 and one of holes 32A is coupled to stud coupler 34. Strap 32 is tensioned about rail 100 to snugly press surface 23 of base 20 against rail 100. Once assembly 10 is attached to rail 100, an assembly (not shown in FIG. 12) such as a urinal bottle can be supported by holder 50. FIG. 13 illustrates assembly 10 with a weighted accessory (not shown) being held by holder 50, and with rail 100 oriented at an angle α. For clarity of illustration, only the weight of the weighted accessory is indicated by the downwardly-directed arrow referenced by “W”. With rail 100 so-angled, plate 40, D-ring holder 50 and weighted accessory W remain vertically aligned with the force of gravity to F_{g}, while base 20 has rotated (along with rail 100) with respect to plate 40 through angle α. In this way, weighted accessory W remains in a vertical (e.g., non-spilling state in the case of a urinal bottle) at a location that is easily accessible by the patient and their caregivers.

The advantages of the present invention are numerous. The rotating holder assembly provides a structure for supporting a variety of items found at a patient's hospital bed in a way that makes the items readily accessible to the patient regardless of the bed's angular orientation. The assembly can be configured for support of a variety of items to include those subject to frequent misplacement, tangling, or spilling. No tools are required to couple the assembly to a bed rail and the assembly is readily repositioned if needed. The present invention will prevent a patient's bed from becoming a “catch all” depository for medical treatment apparatus, personal hygiene accessories, and patient comfort accessories.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A rotating holder assembly, comprising:
a base defining (i) a first surface and a second surface in opposition to said first surface, (ii) an open-ended tubular portion located between said first surface and said second surface wherein said tubular portion has an elongate cross-sectional shape, (iii) a cylindrical post coupled to and extending perpendicularly away from said first surface wherein said post terminates in an outboard end, and (iv) a cap coupled to said outboard end of said post wherein said cap defines a substantially hemispherical shape extending away from said outboard end and wherein a diameter of said cap is greater than a diameter of said post;
a strap assembly including (i) a stretchable strap extending through said tubular portion of said base, and (ii) a coupler for securing said stretchable strap into a loop of selectable size;
a plate having a hole extending therethrough, wherein an axial length of said hole is less than an axial length of said post, and wherein a diameter of said hole is less than said diameter of said cap and greater than said diameter of said post; and
an accessory holder coupled to said plate.

2. A rotating holder assembly as in claim 1, wherein said axial length of said hole is between approximately 0.80 to approximately 0.90 of said axial length of said post.

3. A rotating holder assembly as in claim 1, wherein said second surface of said base comprises a non-skid surface.

4. A rotating holder assembly as in claim 1, further comprising a non-skid material coupled to said second surface.

5. A rotating holder assembly as in claim 1, wherein said accessory holder is selected from the group consisting of a ring, a cradle, and a multi-tube guide.

6. A rotating holder assembly as in claim 1, wherein said cap is radially compressible.

7. A rotating holder assembly as in claim 1, wherein said cap is removably attached to said post.

8. A rotating holder assembly, comprising:
a base defining (i) a first surface and a second surface in opposition to said first surface wherein said second surface is a non-skid surface, (ii) an open-ended tubular portion located between said first surface and said second surface wherein said tubular portion has an elongate cross-sectional shape, (iii) a cylindrical and partially split post coupled to and extending perpendicularly away from said first surface wherein said post terminates in a plurality of separated outboard ends, and (iv) a plurality of caps wherein each of said caps is coupled to a corresponding one of said outboard ends and wherein a combination of said caps define a substantially hemispherical shape having a first diameter when no radial compression force is applied to said caps and a second diameter when a radial compression force is applied to said caps, said first diameter being greater than said second diameter and greater than a diameter of said post;
a strap assembly including (i) a stretchable strap extending through said tubular portion of said base, and (ii) a coupler for securing said stretchable strap into a loop of selectable size;
a plate having a cylindrical hole extending therethrough, wherein an axial length of said hole is between approximately 0.80 to approximately 0.90 of an axial length of said post, wherein a diameter of said hole is greater than said diameter of said post, and wherein said diameter of said hole is (i) greater than said second diameter of said hemispherical shape, and (ii) less than said first diameter of said hemispherical shape; and
an accessory holder coupled to said plate.

9. A rotating holder assembly as in claim 8, wherein said non-skid surface comprises a non-skid material.

10. A rotating holder assembly as in claim 8, wherein said accessory holder is selected from the group consisting of a ring, a cradle, and a multi-tube guide.

11. A rotating holder assembly kit, comprising:
a base defining (i) a first surface and a second surface in opposition to said first surface, (ii) an open-ended tubular portion located between said first surface and said second surface wherein said tubular portion has an elongate cross-sectional shape, (iii) a cylindrical and partially split post coupled to and extending perpendicularly away from said first surface wherein said post terminates in a plurality of separated outboard ends, and (iv) a plurality of caps wherein each of said caps is coupled to a corresponding one of said outboard ends and wherein a combination of said caps define a substantially hemispherical shape having a first diameter when no radial compression force is applied to said caps and a second diameter when a radial compression force is applied to said caps, said first diameter being greater than said second diameter and greater than a diameter of said post;
a strap assembly including (i) a stretchable strap extending through said tubular portion of said base, and (ii) a coupler for securing said stretchable strap into a loop of selectable size;
a first plate having a first hole extending therethrough, wherein an axial length of said first hole is less than an axial length of said post, and wherein a diameter of said first hole is (i) greater than said second diameter of said hemispherical shape, and (ii) less than said first diameter of said hemispherical shape;
a ring coupled to said first plate;
a second plate having a second hole extending therethrough, wherein an axial length of said second hole is less than an axial length of said post, and wherein a diameter of said second hole is (i) greater than said second diameter of said hemispherical shape, and (ii) less than said first diameter of said hemispherical shape;
a cradle coupled to said second plate;
a third plate having a third hole extending therethrough, wherein an axial length of said third hole is less than an axial length of said post, and wherein a diameter of said third hole is (i) greater than said second diameter of said hemispherical shape, and (ii) less than said first diameter of said hemispherical shape; and
a multi-tube holder coupled to said third plate.

12. A rotating holder assembly kit as in claim 11, wherein each of said axial length of said first hole, said axial length of said second hole, and said axial length of said third hole is between approximately 0.80 to approximately 0.90 of said axial length of said post.

13. A rotating holder assembly as in claim 11, wherein said second surface of said base comprises a non-skid surface.

14. A rotating holder assembly as in claim 11, further comprising a non-skid material coupled to said second surface.
